(19) United States
(12) Patent Application Publication
(10) Pub. No.: US 2015/0121315 A1
(43) Pub. Date: Apr. 30, 2015

(54) GESTURE BASED METHOD FOR ENTERING MULTI-VARIABLE DATA ON A GRAPHICAL USER INTERFACE.

(71) Applicant: David Michael Glenn, Menlo Park, CA (US)

(72) Inventor: David Michael Glenn, Menlo Park, CA (US)

(73) Assignee: David Michael Glenn, Menlo Park, CA (US)

(21) Appl. No.: 14/512,437

(22) Filed: Oct. 12, 2014

Related U.S. Application Data
(60) Provisional application No. 61/896,109, filed on Oct. 27, 2013.

(51) Int. Cl. G06F 3/0488

(52) U.S. Cl. CPC G06F 3/04883
USPC 715/863

(57) ABSTRACT

A gesture based method for entering multi-dimensional data on a graphical user interface, for use in conjunction with a portable electronic device with a touch screen display, comprising a plurality of vertical and horizontal gestures to specify two different but logically related items of data.

### CROSS REFERENCE TO RELATED APPLICATIONS

This application claims priority under 35 U.S.C. §119 (e) to U.S. provisional patent application Ser. No. 61/896,109 filed on Oct. 27, 2013, the contents of which is hereby incorporated herein by reference in its entirety for all purposes.

### COPYRIGHT NOTICE

Pursuant to 37 C.F.R. 1.71(e), applicants note that a portion of this disclosure contains material that is subject to and for which is claimed copyright protection, such as, but not limited to, copies of paper forms, screen shots, user interfaces, electronic medical record formats, or any other aspects of this submission for which copyright protection is or may be available in any jurisdiction. The copyright owner has no objection to the facsimile reproduction by anyone or the patent document or patent disclosure, as it appears in the Patent Office patent file or records. All other rights are reserved, and all other reproduction, distribution, creation of derivative works based on the contents, public display, and public performance of the application or any part thereof are prohibited by applicable copyright law.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF INVENTION

This invention relates to the use of gesture information in a graphical user interface on a touch screen display.

### BACKGROUND OF THE INVENTION

Gesture based graphical user interfaces like those found on tablets and smartphones commonly give users the ability to enter data into various user interface controls. Most often, that data has a one-to-one relationship with the user interface control and the value deposited by the user into it. However, when a value is required that is multi-part, sometimes also referred to as multi-dimensional, multi-variable or multi-value, few viable solutions exist. For the sake of this disclosure, multi-variable will be used for consistency, without any intended limitation. In such cases, the application program developer is required to be creative in programming the user interface control means since no standard is available or likely possible. Often, the input means for a single value include such options as (non-exhaustive list), combo boxes, check boxes, radio button group, or a date or time selector. When a user interface control requires a type of data that has multiple parts, where each part has at least some logical relationship to the other parts, no suitable control or widget exists in the prior art because the objectives of the user interface experience may be application or domain specific. One example of such a requirement is to limit the number of taps required to specify all parts of the multi-variable. This may be a function of the type of data required for each part, such as value ranges, increments, defaults, numeric vs. textual, etc. Further, the requirement for a new value verses editing a pre-existing value is also an issue requiring a creative solution.

It is thus apparent that there is a requirement for a simple solution for entering multi-variable data in a way optimized for gesture-based interfaces.

### SUMMARY OF THE INVENTION

The preferred embodiment of the present invention enables a process-based means of specifying the individual values of a multi-variable data type using gesture-based means. On a typical gesture sensitive interface, a user can accomplish this task using a single finger of one hand. In a second embodiment, a user can specify the values for a two-dimensional variable using a related process-based means.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 represents an application program window for an electronic anesthesia record on a portable electronic device with a touch screen display in accordance with an embodiment of the present invention.

FIG. 2 represents an editor for configuring a multi-dimensional variable in accordance with an embodiment of the present invention.

FIG. 3a represents a process for using a gesture-based means for entering data for a multi-dimensional variable in accordance with an embodiment of the present invention.

FIG. 3b represents a process for using a gesture-based means for entering data for a multi-dimensional variable in accordance with an embodiment of the present invention.

FIG. 4 represents a means of showing the values selected for a multi-dimensional variable in accordance with an embodiment of the present invention.

FIG. 5 represents the result of entering data for a multi-dimensional variable in accordance with an embodiment of the present invention.

FIG. 6 represents a process of entering two-dimensional data using a gesture-based means in accordance with an embodiment of the present invention.

FIG. 7 represents a process of entering two-dimensional data using a gesture-based means in accordance with an embodiment of the present invention.

### DETAILED DESCRIPTION OF THE INVENTION

The above deficiencies and other problems associated with entering multidimensional information using gesture based means are reduced or eliminated by the disclosed methods as realized on a portable multi-function device with a gesture-sensitive interface. In all embodiments, a graphical user interface (GUI) is produced by an application program operating on the portable multi-function device having one or more processors, memory and one or more modules, programs or sets of instructions stored in the memory for performing multiple functions. In some embodiments, the user interacts with the GUI primarily through touch gestures such as one or more fingers directly contacting the gesture-sensitive interface, however other means may also include, but not limited to, a stylus, kinetic motion gestures or even audio command, sounds or phrases. Instructions for performing these functions may be included in a computer program product configured for execution by one or more processors.

It shall be understood that, although the terms first, second, etc. may be used herein to describe various elements, these elements should not be limited to these terms. These terms are only used to distinguish one element from another. The terminology used in the description of the invention herein is for the purpose of describing particular embodiments only and is not intended to be limiting of the invention. Further, as used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, the use of particular gestures is representative only and the reliance of touch-sensitivity is not a requirement as other means of enabling gestures may presently or in the future be possible. Nor is it implied that the use of the word “gesture” excludes the possibility of a combination of other gestures. Further, the invention does not rely on any particular implementation of a multi-functional, gesture-sensitive device or any version of its operating system and any graphics displayed are not intended to convey a reliance on any particular vendor or version thereof. It shall further be understood by a person of ordinary skill in the art, that how the stock operating system, provided by the vendor of the multi-function gesture-sensitive device, implements the ability to program gesture controls and other vendor supplied application enablements is not part of the invention and has not been modified in any way by the invention, sometimes referred to as “hacks”, “jailbreaks”, “rooting” or “privilege escalations” to name a few.

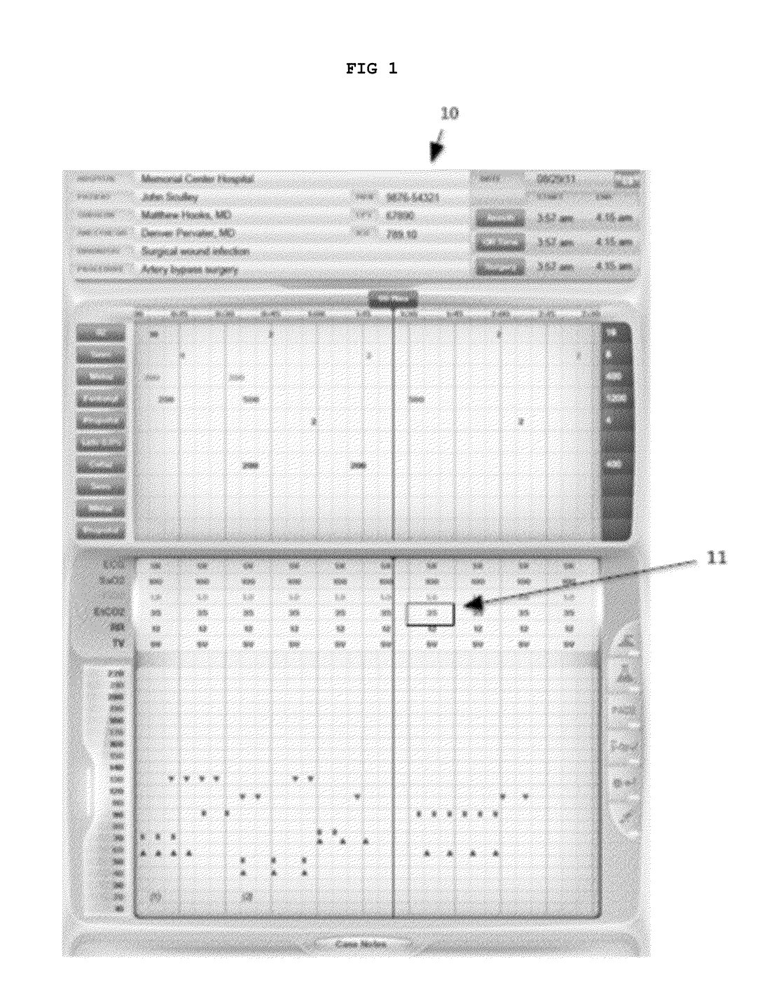

The various embodiments of the invention are realized in an electronic anesthesia record (FIG. 1). The electronic anesthesia record is both an apparatus and a plurality of computer-implemented methods used in conjunction with a portable multifunction device with a gesture-sensitive display and reduced to practice in the form of an application program. The application program displays an application program window (10). It should be noted that the use of terminology such as window, sub-window, view and sub-view are representative of a concept in graphical user interface programming and are not limited in any way to one particular vendors approach. Some vendor's application programming interfaces (API) use terms like window/sub-window and panel/sub-panel. All are considered equivalent and exchangeable herein and are meant to convey a logical rather than a physical function, which a person of ordinary skill in programming a particular vendor's API could implement without undue experimentation.

The challenge on a multi-functional touch screen device is to enable a user-friendly means of entering complex data with as few gestures, taps, slides, audio sounds or other gestures as possible. Users are annoyed by cumbersome data entry processes, which limit product utility and adoption. The present invention was developed to aid an anesthesiologist, possibly during a procedure, to rapidly specify vital sign data in an electronic anesthesia record. Where such data is single dimensional, the enablements provided by the multi-functional device's operating system, such as iOS, are often sufficient. However, when that data is two or sometimes three (or more) dimensional, standard data entry means are cumbersome using stock UI controls. FIG. 1 is an electronic anesthesia record (10) showing a cell of the vital sign grid as type of multi-variable field (11). The value required for the cell is a function of the type of vital sign configured by the user for the given row. Examples of multi-dimensional data include:
1. Blood pressure, which has two dimensions, systolic and diastolic.
2. Ventilation has two dimensions, tidal volume measured in cc, normal range 50-3000 cc and ventilator mode (the wave form of mechanical ventilator cycles), example values are:
   a. SV (Spontaneous Ventilation)
   b. CMV (Continuous Mechanical Ventilation)
   c. SMIV (Synchronized Intermittent Mandatory Ventilation)
   d. ACV (Assist control ventilation)
   e. PCV (Pressure control ventilation)
   f. PSV (Pressure Support ventilation)
   g. CPAP (Continuous Positive Airway Pressure)
   h. PEEP (Positive End-Expiratory Pressure)
3. Electrocardiogram intervals are two dimensions. Changes in these intervals from the normal range can be significant early indicators of impending cardiac ischemia and arrest. The first dimension is time in second or milliseconds, range 0.01-0.5 sec or 1-50 milliseconds. The second dimension is ECG intervals, i.e. segments between the different peaks in the ECG tracing. Example values are
   a. ST
   b. QT
   c. PQ
   d. R-R
4. Arterial blood gas is an example of a six-dimensional vital sign. Blood taken from an artery is analyzed in a lab or in a semi-portable analyzer, to give measurements of dissolved gases in the patients blood revealing important diagnostic clues to what disease processes are going on in the lungs, kidneys, liver, heart, blood, etc. The customary format is: pH/pCO2/pO2/BC/SaO2/BE written like 7.40/40/100/24/99%/−2 translated to:
   a. pH—range 6.0-8.0
   b. partial pressure of CO2—range 10-100 mmHg
   c. partial pressure of O2-50-400 mmHg
   d. Bicarbonate—0-50 mEq/L
   e. Blood O2 Saturation—range 50-100%
   f. Bass Excess—range −10-10 mmol/L

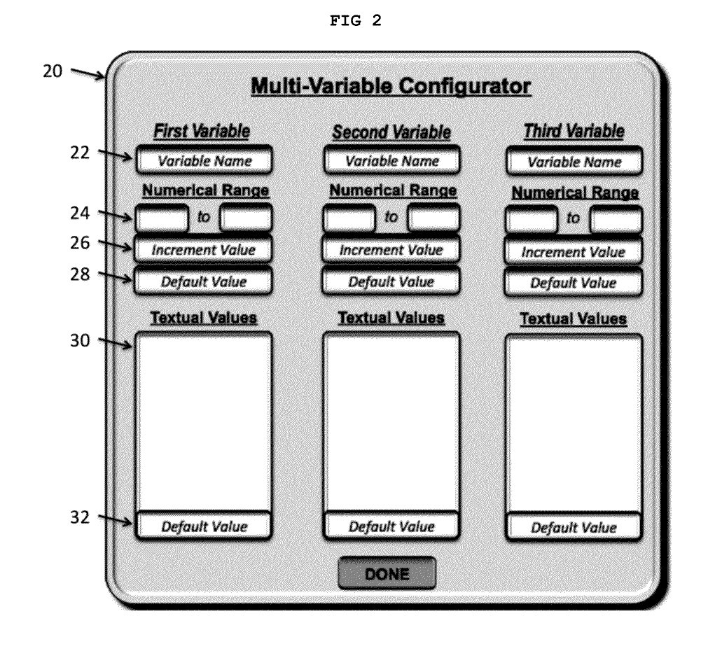

FIG. 2 (20) is a representative means of configuring the metadata required for a given multi-variable field. The application provides a means of calling up the multi-variable configurator by gesturing over a button or some other means. The user has a choice to configure the variable as a numeric or an abstract type. If numeric, a range is specified (FIG. 2, 24) along with an increment (FIG. 2, 26) and a default or starting value (FIG. 2, 28). If an abstract value, then the anesthesiologist will specify one or more values (FIG. 2, 30) along with a default value (FIG. 2, 32). Abstract types may include any list of items, such as but not limited to, a list of text values or a list of images or a list of sounds. The preferred embodiment will consider lists of text values. Although, the shown multi-variable configurator (20) is capable of configuring three variables, other configurators (not shown), are capable of handling variables of any number of dimensions. Before attempting to enter data into a multi-variable field (FIG. 1, 11), the application program will require the anesthesiologist configure the values specified above.

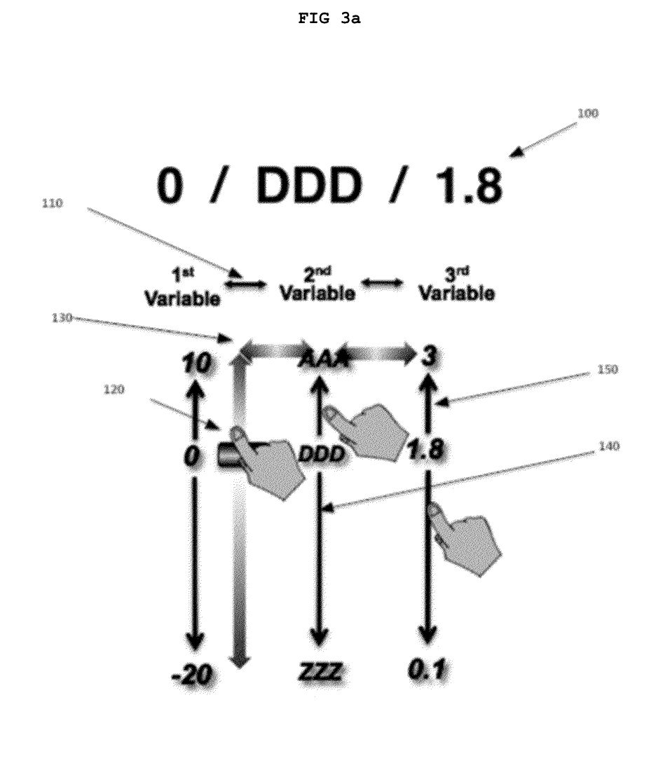

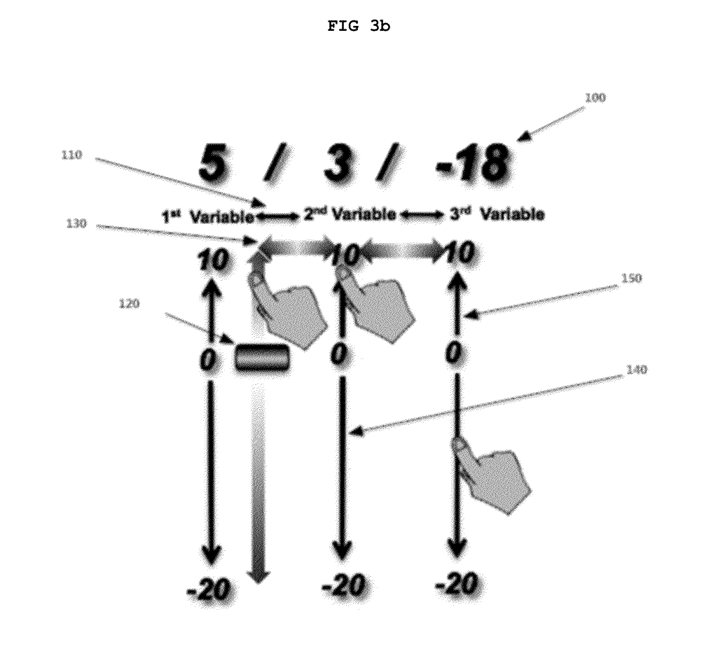

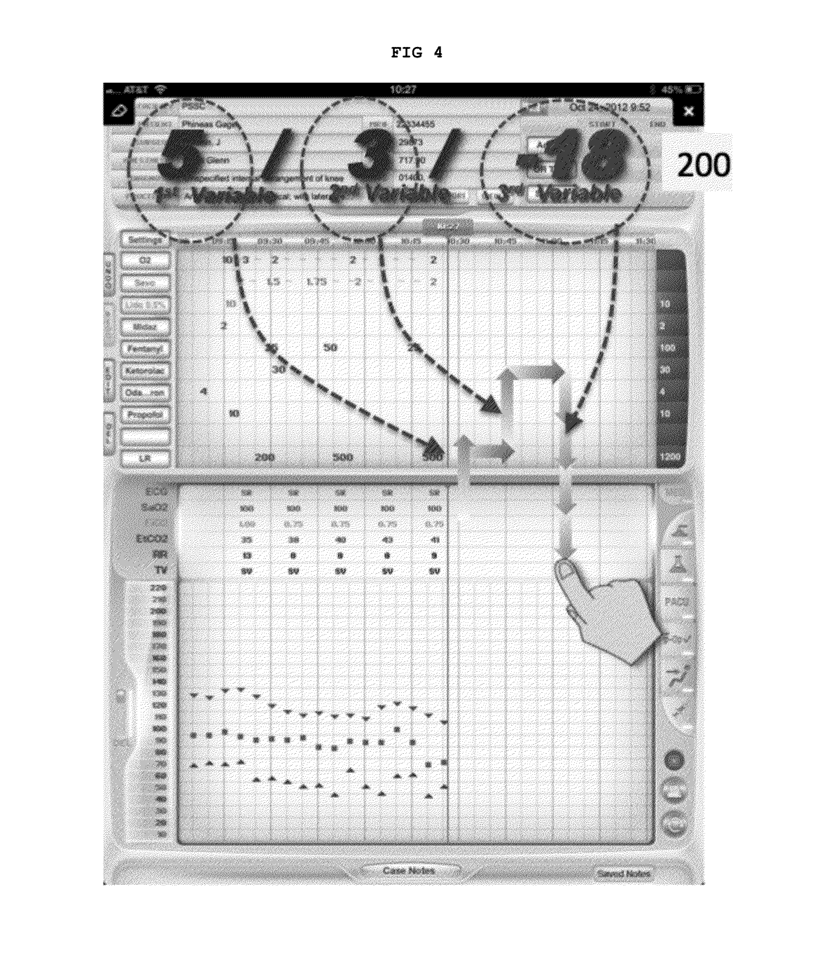

To specify the values for a multi-variable, the anesthesiologist will perform the following process:
The anesthesiologist performs a first gesture (single finger touch and hold) (FIG. 3a/3b, 120) over the representative field (FIG. 1, 11). When the editing process begins, the application program displays the status of the multi-variable near the top of the application program window (FIG. 3a/3b, 100; FIG. 4, 200). The information contained in the status is comprised of, at least one of the values making up the multi-variable, a name identifying each variable, and a separator between each variable. For the status, application program initially displays the default value for each variable separated by a “/” if the field was previously empty or a saved value from a previous edit will be displayed (example “3/4/5”). The editing process starts with the first variable. The application program assigns a context to each variable. The context is a logical means of associating the gesture inputs to the variable under edit. If a multi-variable has N variables, the application program will maintain N contexts. If the multi-variable has more than three parts, then the status scrolls as the anesthesiologist moves through the variables. For example, TABLE 1 shows a multi-variable with six variables (A-F).

TABLE 1

| VARIABLE BEING EDITED | STATUS DISPLAYED |
|---|---|
| A | A/B/C |
| B | A/B/C |
| C | A/B/C |
| D | B/C/D |
| E | C/D/E |
| F | D/E/F |

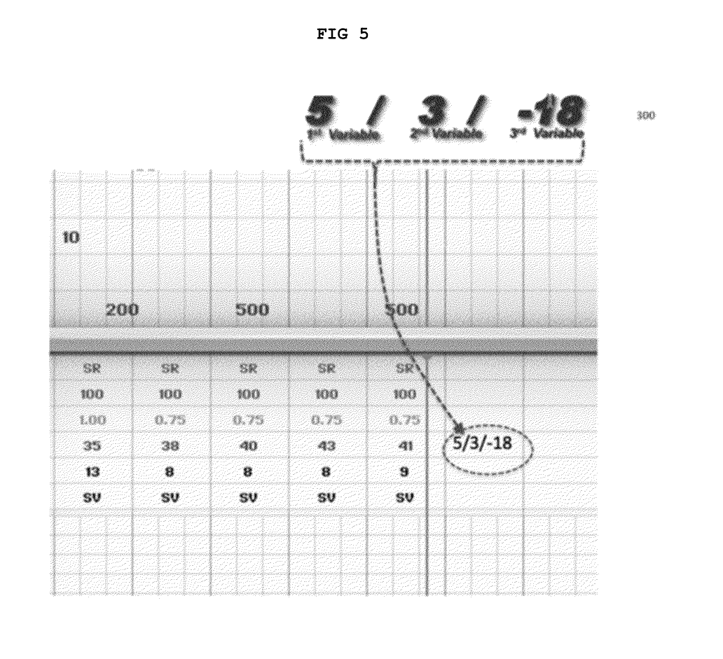

The anesthesiologist performs a second gesture, different from the first (single finger vertical slide without lifting the finger from the previous gesture), (FIG. 3a/3b, 125). If the variable is numeric, an up gesture (slide) will add the increment to the variable's current value until the high range limit is reached (if one is configured), a down gesture (slide) will subtract the increment from the variable's current value until the low range value is reached (if one is configured). If the variable is an abstract type, an up gesture (slide) will move up the list of available values starting at the default until the first list value, a down gesture (slide) will move down the list of available values until the last list value.
The anesthesiologist performs a third gesture (single finger horizontal slide without lifting the finger from the previous gesture) (FIG. 3a/3b, 130). The third gesture changes the context to the next variable, such as from variable one to variable two and ends the editing of the previous variable (FIG. 3a/3b, 110). Hence, the application program transitions from context one to context two. The third gesture performed in the opposite direction changes the context to the previous variable, such as from variable three to variable two. A twice-performed third gesture (slide of two horizontal increments) moves the context by two variables, such as from variable one to variable three. The question arises as to which horizontal direction moves the context to the next variable or back to the previous. For example, when should right slides increment from variable one to two as opposed to left slides. In the preferred embodiment, the application program splits the electronic anesthesia record (FIG. 1, 10) vertically down the middle (as counted in pixels) making a median. If the cell of the vital sign grid (FIG. 1, 11) is predominately on the left of the median, then a right horizontal slide advances the context from variable one to two. If the cell of the vital sign grid (FIG. 1, 11) is predominately on the right of the median, then a left slide advances the context from variable one to two. Further, the question as to how far the horizontal should be to change the context from variable N to N+1 or from variable N to N−1. In the preferred embodiment, the application senses the width of the anesthesiologist's finger as applied to the surface of the gesture-sensitive display and sets the distance to that width. Therefore, if the user's finger is 0.5 inches wide, then the slide distance is 0.5 inches.
The anesthesiologist will repeat the second and third gestures until the N^{th} variable has a value (FIG. 3a/3b, 140, 150). Once the anesthesiologist lifts her finger from the gesture-sensitive interface, the application program will associate the value for the multi-variable data to the user interface control in the vital sign editor (FIG. 5, 300). FIG. 4 provides an overview of the gestures performed.

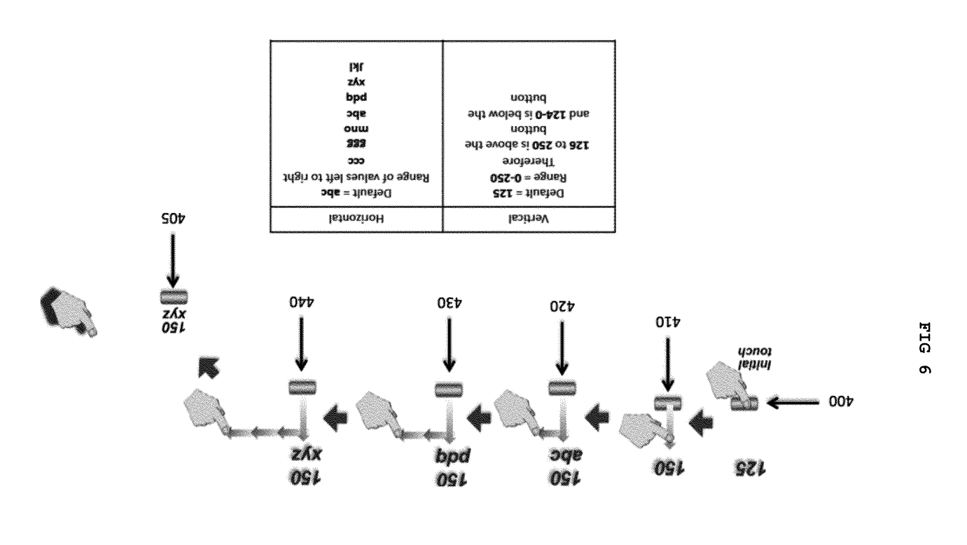

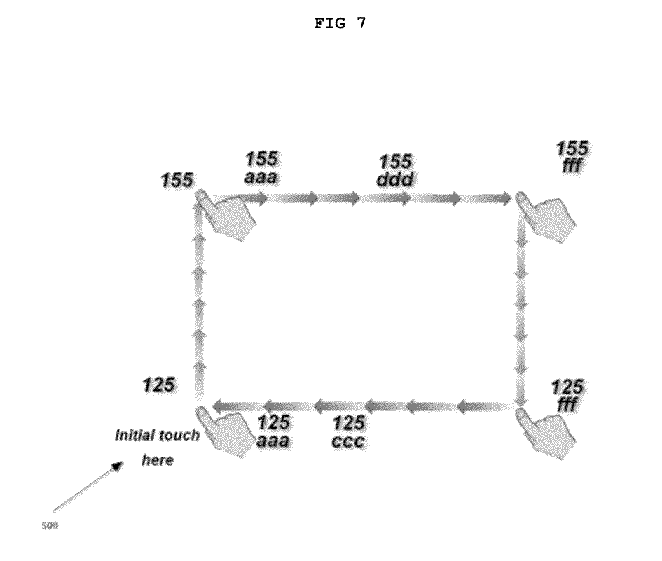

FIG. 6 and FIG. 7 demonstrate a second embodiment of the invention for only two-dimensional variables. To specify the values for a multi-variable, the anesthesiologist will perform a process similar to the first embodiment, except instead of performing a horizontal gesture to change context to the Nth+1 variable, the user application program auto-context changes to the second variable.

The anesthesiologist performs a first gesture (single finger touch and hold) (FIG. 6, 400) over the representative field. When the editing process begins, the application program displays the status of the multi-variable near the top of the application program window. The information contained in the status is comprised of, at least one of the values making up the two dimensional variable, a name identifying each variable, and a separator between each variable. For the status, application program initially displays the default value for each variable separated by a “/” if the field was previously empty or a saved value from a previous edit will be displayed (example “¾”).

The anesthesiologist performs a second gesture, different from the first (single finger vertical slide without lifting the finger from the previous gesture), (FIG. 6, 410). If the variable is numeric, an up gesture (slide) will add the increment to the variable's current value until the high range limit is reached (if one is configured), a down gesture (slide) will subtract the increment from the variable's current value until the low range value is reached (if one is configured). If the variable is an abstract type, an up gesture (slide) will move up the list of available values starting at the default until the first list value, a down gesture (slide) will move down the list of available values until the last list value.

The anesthesiologist performs a third gesture (single finger horizontal slide without lifting the finger from the previous gesture) (FIG. 6, 420). The application program initially displays the default value for the second variable. If the variable is numeric, an right gesture (slide) will add the increment to the variable's current value until the high range limit is reached (if one is configured), a left gesture (slide) will subtract the increment from the variable's current value until the low range value is reached (if one is configured). If the variable is an abstract type, an right gesture (slide) will move up the list of available values starting at the default until the first list value, a left gesture (slide) will move down the list of available values until the last list value.

What is claimed is:

1. A computer-implemented method performed by an application program on a gesture-sensitive interface for entering multi-variable data, via gesture based means, the method comprising the steps of:
performing a first gesture over a user interface control on a graphical user interface to initiate the editing process, the user interface control containing a multi-variable, the multi-variable comprised of one to N variables;
displaying the status of at least one variable of the multi-variable;
performing a second gesture to specify the value of the variable associated to the current context such that the application program establishes a reference point where the second gesture begins and correlates the vertical distance from the reference point to the focus of the second gesture to the value of the variable in the current context, the application program updating the status of the variable associated to the current context in real time as the second gesture is performed;
performing a third gesture to change context to the next context such that the horizontal distance from the location of the focus of the first gesture and the location of the focus of the third gesture at the end of the third gesture increases;
repeating the second and third gestures in succession until the value of the N^{th} variable has been specified.

2. The computer-implemented method of claim 2 wherein the first direction slide gesture is in a vertical direction, in a horizontal direction, or in a diagonal direction.

3. The computer-implemented method of claim 2 wherein the second direction slide gesture is in a vertical direction, in a horizontal direction, or in a diagonal direction.

4. The computer-implemented method of claim 1 wherein each of the first through nth variables do not display overlapping the others.

5. A computer-implemented method performed by an application program on a gesture-sensitive interface for entering two-dimensional data, via gesture based means, the method comprising the steps of:
performing a first gesture over a user interface control on a graphical user interface to initiate the editing process, the user interface control containing a two-dimensional variable, the two-dimensional variable comprised of a first and second variable;
displaying the status of first and second variables;
performing a second gesture to specify the value of the first variable such that the application program establishes a reference point where the second gesture begins and correlates the vertical distance from the reference point to the focus of the second gesture to the value of the first variable, the application program updating the status of the first variable in real time as the second gesture is performed;
performing a third gesture to specify the value of the second variable such that the application program establishes a reference point where the second gesture begins and correlates the horizontal distance from the reference point to the focus of the second gesture to the value of the second variable, the application program updating the status of the second variable in real time as the third gesture is performed.
